(19) United States
(12) Patent Application Publication
(10) Pub. No.: US 2026/0180988 A1
(43) Pub. Date: Jun. 25, 2026

(54) Authorization for AI/ML Model Sharing between Different Vendors

(71) Applicant: TELEFONAKTIEBOLAGET LM ERICSSON (PUBL), Stockholm (SE)

(72) Inventors: Christine Jost, Lund (SE); Ferhat Karakoc, Istanbul (TR); Jing Yue, Stockholm (SE); Dan Xu, Göteborg (SE); Ulf Mattsson, Göteborg (SE); Cheng Wang, Shanghai (CN); Songmao Li, Shanghai (CN)

(21) Appl. No.: 19/126,044

(22) PCT Filed: Nov. 2, 2023
(86) PCT No.: PCT/EP2023/080568

§ 371 Date: Apr. 30, 2025

(30) Foreign Application Priority Data
Nov. 7, 2022 (WO) PCT/CN2022/130365

(51) Int. Cl. H04L 9/40; H04L 41/40; H04L 67/51

(52) U.S. Cl. CPC H04L 63/10; H04L 41/40; H04L 67/51

(57) ABSTRACT

Embodiments include methods for a consumer network function (NFc). Such methods include sending, to a network repository function (NRF), a first request for an access token associated with a machine learning (ML) model. The first request includes an analytics identifier (ID) associated with the ML model. Such methods include receiving from the NRF a first response that includes the access token, which includes a vendor ID associated with the NFc. Such methods include sending, to a producer NF (NFp), a second request for the ML model. The second request includes the access token and the analytics ID associated with the ML model. Such methods include receiving from the NFp a second response that includes the ML model or a one-time-use universal resource locator (URL) associated with a second NF, from which the ML model can be obtained. Other embodiments include complementary methods for the NFp, the NRF, and an ADRF.

### TECHNICAL FIELD

The present application relates generally to the field of communication networks, and more specifically to techniques for security of artificial intelligence/machine learning (AI/ML) models used to generate analytics in a communication network (e.g., a 5G core network).

### BACKGROUND

Currently the fifth generation (5G) of cellular systems is being standardized within the Third-Generation Partnership Project (3GPP). 5G is developed for maximum flexibility to support various use cases including enhanced mobile broadband (eMBB), machine type communications (MTC), ultra-reliable low latency communications (URLLC), side-link device-to-device (D2D), and several other use cases.

At a high level, the 5G System (5GS) consists of an Access Network (AN) and a Core Network (CN). The AN provides UEs connectivity to the CN, e.g., via base stations such as gNBs or ng-eNBs described below. The CN includes a variety of Network Functions (NF) that provide a wide range of different functionalities such as session management, connection management, charging, authentication, etc.

FIG. 1 illustrates a high-level view of an exemplary 5G network architecture, which includes a Next Generation Radio Access Network (NG-RAN, 199) and a 5G Core (5GC, 198). The NG-RAN can include one or more gNodeB's (gNBs, e.g., 100, 150) connected to the 5GC via one or more NG interfaces (e.g., 102, 152). More specifically, the gNBs can be connected to one or more Access and Mobility Management Functions (AMFs) in the 5GC via respective NG-C interfaces and to one or more User Plane Functions (UPFs) in the 5GC via respective NG-U interfaces. Various other network functions (NFs) can be included in the 5GC, as described in more detail below.

In addition, the gNBs can be connected to each other via one or more Xn interfaces (e.g., 140 between gNBs 100, 150). The radio technology for the NG-RAN is often referred to as New Radio (NR). With respect to the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells.

NG RAN logical nodes shown in FIG. 1 include a Centralized Unit (CU or gNB-CU) and one or more Distributed Units (DU or gNB-DU). CUs (e.g., 110) are logical nodes that host higher-layer protocols and perform various gNB functions such controlling the operation of DUs. In contrast, DUs (e.g., 120, 130) are decentralized logical nodes that host lower layer protocols and can include, depending on the functional split option, various subsets of gNB functions. A CU connects to one or more DUs over respective F1 logical interfaces (e.g., 122, 132 in FIG. 1).

Another change in 5G networks (e.g., in 5GC) is that traditional peer-to-peer interfaces and protocols found in earlier-generation networks are modified and/or replaced by a Service Based Architecture (SBA) in which Network Functions (NFs) provide one or more services to one or more service consumers. This can be done, for example, by Hyper Text Transfer Protocol/Representational State Transfer (HTTP/REST) application programming interfaces (APIs). In general, the various services are self-contained functionalities that can be changed and modified in an isolated manner without affecting other services.

Furthermore, the services are composed of various “service operations,” which are more granular divisions of the overall service functionality. The interactions between service consumers and producers can be of the type “request/response” or “subscribe/notify.” In the 5G SBA, network repository functions (NRF) allow every network function to discover the services offered by other network functions, and Data Storage Functions (DSF) allow every network function to store its context. This 5G SBA model is based on principles including modularity, reusability, and self-containment of NFs, which can enable network deployments to take advantage of the latest virtualization and software technologies.

A 5GC NF that is of particular interest in the present disclosure is the Network Data Analytics Function (NWDAF). This NF provides network analytics information (e.g., statistical information of past events and/or predictive information) to other NFs on a network slice instance level. The NWDAF can collect data from any 5GC NF. Note that a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice.

Machine learning (ML) is a type of artificial intelligence (AI) that focuses on the use of data and algorithms to imitate the way that humans learn, gradually improving accuracy as more data becomes available. ML algorithms build models based on sample (or “training”) data, with the models being used subsequently to make predictions or decisions. ML algorithms can be used in a wide variety of applications (e.g., medicine, email filtering, speech recognition, etc.) in which it is difficult or unfeasible to develop conventional algorithms to perform the needed tasks. A subset of ML is closely related to computational statistics.

The 5G system architecture allows any NF to obtain analytics from an NWDAF using a Data Collection Coordination Function (DCCF) and associated Ndccf services. The NWDAF can also store and retrieve analytics information from an Analytics Data Repository Function (ADRF). 3GPP TS 23.288 (v17.2.0) specifies that NWDAF is the main NF for computing analytics reports, and classifies NWDAF into two sub-functions (or logical functions): Analytics Logical Function (AnLF), which performs analytics procedures; and Model Training Logical Function (MTLF), which performs training and retraining of ML models used by the AnLF.

### SUMMARY

AI/ML models (or more simply, ML models) are considered important intellectual property of their owners (e.g., 5GC vendors) and, as such, must have their confidentiality and integrity protected at all times. 3GPP is studying the feasibility of sharing ML models between NWDAF-AnLF and NWDAF-MTLF that are provided by different vendors. In this arrangement, there is a need for authentication and authorization of the receiving NWDAF and for security of the ML model during transfer and storage. Current solutions for ML model sharing are based on certain 5GC NFs and features that are not well-aligned with these requirements. Accordingly, improved solutions are needed.

An object of embodiments of the present disclosure is to address these and other problems, issues, and/or difficulties related to ML model security, thereby facilitating the otherwise-advantageous deployment of ML models for network analytics.

Some embodiments of the present disclosure include methods (e.g., procedures) for a consumer NF (NFc) of a communication network (e.g., 5GC).

These exemplary methods include sending, to a network repository function (NRF) of the communication network, a first request for an access token associated with an ML model. The first request includes an analytics identifier (ID) associated with the ML model. These exemplary methods also include receiving from the NRF a first response that includes the access token, which includes a vendor ID associated with the NFc. These exemplary methods also include sending to a producer NF (NFp) of the communication network a second request for the ML model. The second request includes the access token and the analytics ID associated with the ML model. These exemplary methods also include receiving from the NFp a second response that includes one of the following: the ML model, or a one-time-use URL associated with a second NF of the communication network, from which the ML model can be obtained.

Other embodiments include exemplary methods (e.g., procedures) for an NFp of a communication network (e.g., 5GC).

These exemplary methods include registering information associated with an ML model in an NRF of the communication network. The ML model is produced, owned, and/or maintained by the NFp. The registered information includes an analytics ID associated with the ML model, a vendor ID associated with the NFp, and an interoperability ID associated with the NFp and with the ML model. These exemplary methods also include receiving a second request for the ML model from an NFc of the communication network. The second request includes an access token and the analytics ID associated with the ML model. The access token includes a vendor ID associated with the NFc. These exemplary methods also include authorizing the NFc to access the ML model based on a match, correspondence, or relationship between the vendor ID included in the access token and the interoperability ID associated with the NFp and with the ML model.

In some embodiments, these exemplary methods also include, based on authorizing the NFc, sending to the NFc a second response that includes the ML model or a one-time-use URL associated with a second NF of the communication network, from which the ML model can be obtained.

In some embodiments, the second NF associated with the one-time-use URL is the NFp and the exemplary method also includes providing the ML model to the NFc using the one-time-use URL associated with the NFp. In other embodiments, the second NF is an analytics data repository function (ADRF) of the communication network and the exemplary method also includes the following operations:
based on authorizing the NFc, sending to the ADRF a third request for the ML model, wherein the third request includes one of the following: a model ID associated with the ML model, or a second URL associated with the ADRF, from which the ML model can be obtained; and
receiving from the ADRF a third response that includes the one-time-use URL associated with the ADRF, which is sent to the NFc in the second response.

Other embodiments include methods (e.g., procedures) for an NRF of a communication network (e.g., 5GC).

These exemplary methods include registering the following information:
first information associated with an ML model that is produced, owned, and/or maintained by a NFp of the communication network, wherein the first information includes an analytics ID associated with the ML model, a vendor ID associated with the NFp, and an interoperability ID associated with the NFp and with the ML model; and
a vendor ID associated with a NFc of the communication network.

These exemplary methods also include receiving from the NFc a first request for an access token associated with the ML model. The first request includes the analytics ID associated with the ML model. These exemplary methods also include authorizing the NFc to access the ML model based on a match, correspondence, or relationship between the vendor ID associated with the NFc and the interoperability ID associated with the NFp and with the ML model. These exemplary methods also include, based on authorizing the NFc, sending to the NFc a first response that includes the access token, wherein the access token includes the vendor ID associated with the NFc.

Other embodiments include methods (e.g., procedures) for an ADRF of a communication network (e.g., 5GC).

These exemplary methods include receiving, from an NFp of the communication network, a first request to store an encrypted ML model. The first request includes a model ID associated with the ML model and a first URL associated with the NFp, from which the ML model can be obtained. These exemplary methods also include obtaining the ML model from the NFp using the first URL associated with the NFp. These exemplary methods also include sending to the NFp a first response including a second URL associated with the ADRF, from which the ML model can be obtained.

In some embodiments, these exemplary methods also include receiving from the NFp a third request for the ML model. The third request includes the model ID associated with the ML model or the second URL associated with the ADRF. These exemplary methods also include sending to the NFp a third response that includes a one-time-use URL associated with the ADRF, from which the ML model can be obtained.

In various embodiments summarized above, the NFc is an NWDAF (AnLF) and/or the NFp is an NWDAF (MTLF).

Other embodiments include NFc's, NFp's, NRFs, and ADRFs (or network nodes hosting such NFs) that are configured to perform the operations corresponding to any of the exemplary methods described herein. Other embodiments also include non-transitory, computer-readable media storing computer-executable instructions that, when executed by processing circuitry, configure such network nodes or NFs to perform operations corresponding to any of the exemplary methods described herein.

These and other disclosed embodiments can provide various benefits and/or advantages. For example, by providing the ML model owner/producer with the ability to protect the ML model during various transfer, storage, and retrieval scenarios, embodiments improve the security of confidential and/or sensitive ML models and thereby facilitate deployment of such models in a multi-vendor communication network, such as 5GC.

These and other objects, features, and advantages of the present disclosure will become apparent upon reading the following Detailed Description in view of the Drawings briefly described below.

### BRIEF DESCRIPTION OF THE DRAWINGS

FIGS. 1-2 illustrate various aspects of an exemplary 5G network architecture.

FIG. 3 shows a signaling diagram of a network procedure for authorization and authentication of AI/ML model transfer.

FIG. 4 shows a signaling diagram of a procedure involving an NWDAF(AnLF), an NRF, an NWDAF(MTLF), and an ADRF, according to some embodiments of the present disclosure.

FIG. 5 shows an exemplary method (e.g., procedure) for a consumer NF of a communication network, according to various embodiments of the present disclosure.

FIG. 6 shows an exemplary method (e.g., procedure) for a producer NF of a communication network, according to various embodiments of the present disclosure.

FIG. 7 shows an exemplary method (e.g., procedure) for an NRF of a communication network, according to various embodiments of the present disclosure.

FIG. 8 shows an exemplary method (e.g., procedure) for an ADRF of a communication network, according to various embodiments of the present disclosure.

FIG. 9 shows a communication system according to various embodiments of the present disclosure.

FIG. 10 shows a UE according to various embodiments of the present disclosure.

FIG. 11 shows a network node according to various embodiments of the present disclosure.

FIG. 12 shows host computing system according to various embodiments of the present disclosure.

FIG. 13 is a block diagram of a virtualization environment in which functions implemented by some embodiments of the present disclosure may be virtualized.

FIG. 14 illustrates communication between a host computing system, a network node, and a UE via multiple connections, according to various embodiments of the present disclosure.

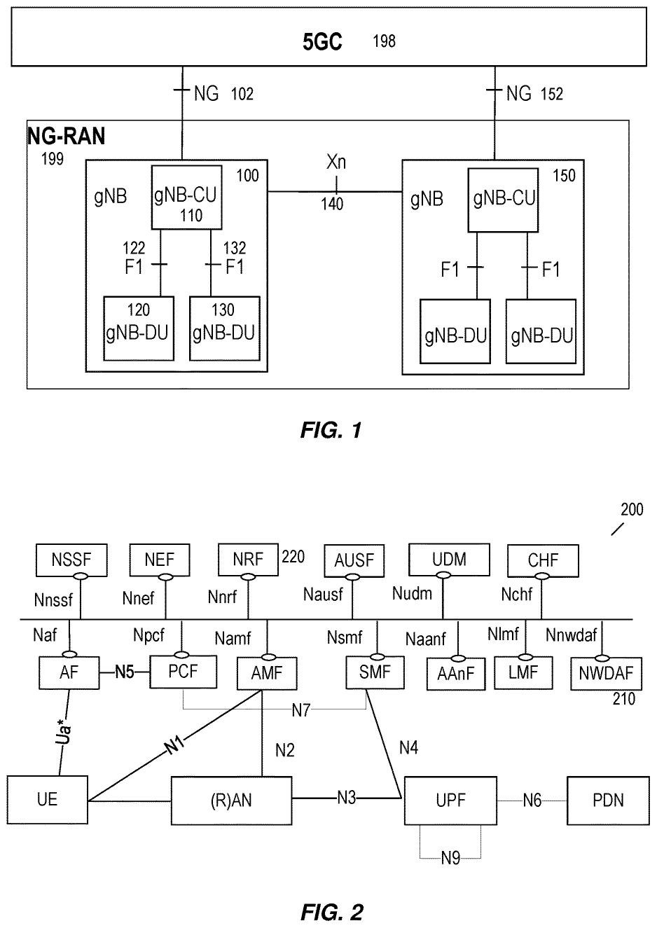

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

In general, all terms used herein are to be interpreted according to their ordinary meaning the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The operations of any methods and/or procedures disclosed herein do not have to be performed in the exact order disclosed, unless operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node) based on its specific characteristics in any given context.

The above definitions are not meant to be exclusive. In other words, various ones of the above terms may be explained and/or described elsewhere in the present disclosure using the same similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is generally used. However, the concepts disclosed herein are not limited to a 3GPP system, and can be applied in any system that can benefit from the concepts, principles, and/or embodiments described herein.

FIG. 2 shows an exemplary non-roaming reference architecture for a 5GC (200 ), with service-based interfaces and various 3GPP-defined NFs within the Control Plane (CP). These include the following:
Application Function (AF, with Naf interface) interacts with the 5GC to provision information to the network operator and to subscribe to certain events happening in operator's network. An AF offers applications for which service is delivered in a different layer (i.e., transport layer) than the one in which the service has been requested (i.e., signaling layer), the control of flow resources according to what has been negotiated with the network. An AF communicates dynamic session information to PCF (via N5 interface), including description of media to be delivered by transport layer.
Policy Control Function (PCF, with Npcf interface) supports unified policy framework to govern the network behavior, via providing PCC rules (e.g., on the treatment of each service data flow that is under PCC control) to the SMF via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events.
User Plane Function (UPF)-supports handling of user plane traffic based on the rules received from SMF, including packet inspection and different enforcement actions (e.g., event detection and reporting). UPFs communicate with the RAN (e.g., NG-RNA) via the N3 reference point, with SMFs (discussed below) via the N4 reference point, and with an external packet data network (PDN) via the N6 reference point. The N9 reference point is for communication between two UPFs.
Session Management Function (SMF, with Nsmf interface) interacts with the decoupled traffic (or user) plane, including creating, updating, and removing Protocol Data Unit (PDU) sessions and managing session context with the User Plane Function (UPF), e.g., for event reporting. For example, SMF performs data flow detection (based on filter definitions included in PCC rules), online and offline charging interactions, and policy enforcement.
Charging Function (CHF, with Nchf interface) is responsible for converged online charging and offline charging functionalities. It provides quota management (for online charging), re-authorization triggers, rating conditions, etc. and is notified about usage reports from the SMF. Quota management involves granting a specific number of units (e.g., bytes, seconds) for a service. CHF also interacts with billing systems.
Access and Mobility Management Function (AMF, with Namf interface) terminates the RAN CP interface and handles all mobility and connection management of UEs (similar to MME in EPC). AMFs communicate with UEs via the N1 reference point and with the RAN (e.g., NG-RAN) via the N2 reference point.
Network Exposure Function (NEF) with Nnef interface—acts as the entry point into operator's network, by securely exposing to AFs the network capabilities and events provided by 3GPP NFs and by providing ways for the AF to securely provide information to 3GPP network. For example, NEF provides a service that allows an AF to provision specific subscription data (e.g., expected UE behavior) for various UEs.
Network Repository Function (NRF, 220) with Nnrf interface-provides service registration and discovery, enabling NFs to identify appropriate services available from other NFs.
Network Slice Selection Function (NSSF) with Nnssf interface-a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice. The NSSF enables other NFs (e.g., AMF) to identify a network slice instance that is appropriate for a UE's desired service.
Authentication Server Function (AUSF) with Nausf interface-based in a user's home network (HPLMN), it performs user authentication and computes security key materials for various purposes.
Network Data Analytics Function (NWDAF, 210) with Nnwdaf interface, described in more detail above and below.
Location Management Function (LMF) with NImf interface-supports various functions related to determination of UE locations, including location determination for a UE and obtaining any of the following: DL location measurements or a location estimate from the UE; UL location measurements from the NG RAN; and non-UE associated assistance data from the NG RAN.

Unified Data Management (UDM) function supports generation of 3GPP authentication credentials, user identification handling, access authorization based on subscription data, and other subscriber-related functions. To provide this functionality, UDM uses subscription data (including authentication data) stored in the 5GC unified data repository (UDR). UDR supports storage and retrieval of policy data by the PCF, as well as storage and retrieval of application data by NEF.

NRF allows every NF to discover the services offered by other NFs, and Data Storage Functions (DSF) allow every NF to store its context. In addition, NEF provides exposure of capabilities and events of the 5GC to AFs within and outside of the 5GC. For example, NEF provides a service that allows an AF to provision specific subscription data (e.g., expected UE behavior) for various UEs.

Communication links between the UE and a 5G network (AN and CN) can be grouped in two different strata. The UE communicates with the CN over the Non-Access Stratum (NAS), and with the AN over the Access Stratum (AS). All the NAS communication takes place between the UE and the AMF via the NAS protocol (NI interface in FIG. 2). Security for the communications over this these strata is provided by the NAS protocol (for NAS) and the PDCP protocol (for AS).

3 GPP Rel-17 enhances the SBA by adding a Data Management Framework that includes a Data Collection Coordination Function (DCCF) and a Messaging Framework Adaptor Function (MFAF), which are defined in detail in 3GPP TR 23.700-91 (v 17.0.0). The Data Management Framework is backward compatible with a Rel-16 NWDAF function, described above. For Rel-17, the baseline for services offered by the DCCF (e.g., to an NWDAF) are the Rel-16 NF Services used to obtain data. For example, the baseline for the DCCF service used by an NWDAF consumer to obtain UE mobility data is Namf_EventExposure.

3GPP TS 23.288 (v17.2.0) specifies that NWDAF is the main network function for computing analytics reports. The 5G system architecture allows any NF to obtain analytics from an NWDAF using a DCCF function and associated Ndccf services. The NWDAF can also store and retrieve analytics information from an Analytics Data Repository Function (ADRF).

3GPP TS 23.288 also classifies NWDAF into two sub-functions (or logical functions): NWDAF Analytics Logical Function (NWDAF AnLF), which performs analytics procedures; and NWDAF Model Training Logical Function (NWDAF MTLF), which performs training and retraining of ML models used by NWDAF AnLF. In the following, the terms “AnLF,” “NWDAF AnLF,” and “NWDAF (AnLF)” will be used interchangeably. Likewise, the terms “MTLF,” “NWDAF MTLF,” and “NWDAF (MTLF)” will be used interchangeably.

3GPP TS 23.288 (v17.2.0) specifies a subscribe/notify procedure for a consumer NF to retrieve ML model(s) associated with one or more Analytics IDs whenever a new ML model has been trained by the NWDAF MTLF and becomes available. This is referred to as ML Model Provisioning and is implemented by the Nnwdaf_MLModelProvision service.

3GPP TS 23.700-81 (v1.1.0) describes a study on enablers for network automation for 5G. One of the objectives of the study is enhanced sharing of trained ML models, which is identified as “Key Issue #5”. The following text from 3GPP TS 23.700-81 describes various aspects of this issue.
Begin 3GPP text

### 7.5 Key Issue #5: Enhance Trained ML Model Sharing

According to the Table 6.0-1, solution #13, #14, #15, #43 and #47 are proposed for Key Issue 5. Solution #13 and #14 supports sharing of model via ML model file format. When the NWDAF (containing MTLF) registers its NF profile with NRF, the solution #13 and #14 provide means to include ML model file formats in its NF profile. In addition, Solution #14 also includes Supported AI Framework in its NF profile.
Solution #15 introduces Interoperable Indicator indicating what an NWDAF containing MTLF decides to share based on business needs.
Solution #47 introduces Interoperable Token indicating that a certain model is agreed to be share based on business agreements and interoperable testing. The solution supports sharing of models as OCI images and can also support ML model file serialization format. The solution supports multiple environments in which models run in different AnLFs. Neither the format nor the environment is specified in 3GPP, these are rather described in a container which is out of scope out 3GPP.
Solution #47 supports all functionality specified in solution #13, #14 and #15.
Solution #43 is mainly about storing models in ADRF and in KI #5 aspects to be studied are how to enhance trained ML Model sharing between NWDAFs from different vendors. Solution #43 is therefore not evaluated in this KI.
The common characteristics to enable trained ML model sharing between different vendors includes:
   a) Interoperability indicator (Solution 15),
   b) Interoperable Token (Solution 47),
   c) ML model filter information i.e., ML model file format supported including serialization file formats (Solution 13 and 14), Supported AI Framework Information (Solution 14).
Both a) and c) parameters are complementary to each other. The interoperable indicator allows the MTLF to determine whether to expose the certain ML models to another provider's AnLF or not, and then if allowed select the model. For a selected trained ML model, the ML model filter information (ML model file format and AI Framework information) indicates the ML environment the ML model is trained in and associated output file format.

### 8.5 Key Issue #5: Enhance Trained ML Model Sharing

It is recommended to use the following principles and procedures as the basis for the normative work.
   The following are the trained ML model sharing parameters to enable ML model sharing between different vendors-Interoperability indicator as specified in Sol #15 and optional Interoperability token as specified in Sol #47.
      The Interoperability indicator indicates a list of NWDAF providers (vendors) that are allowed to retrieve ML models from the NWDAF containing MTLF.
      The Interoperability indicator indicates that the NWDAF containing MTLF supports the interoperable ML models requested by the NWDAFs from the vendors in the list. NOTE: The vendor list indicated by the Interoperability indicator is determined by the NWDAF vendor and is configured in the NWDAF.
      The Interoperability token implicitly maps to an interoperable model information, e.g., file format, platform, etc. The encoding, format, and value of the Interoperability token is up to vendors'implementation; thus, no normative work is needed except defining this IE.
   During registration of NWDAF containing MTLF with NRF, Interoperability indicator and optional Interoperability token to trained ML model sharing are provided as part of NF profile to the NRF.
   During NWDAF containing MTLF discovery procedure, the consumer i.e., NWDAF may include Interoperability indicator and optional Interoperability token per Analytics ID(s) in the discovery request.
NOTE: When ML model provider MTLF and ML model consumer NWDAF belong to different vendors, how the ML model privacy is supported is in scope of SA WG3.
**End 3GPP text***

To summarize, the recommendation outlined above for key issue #5 is to introduce an interoperability indicator (or ID), which “indicates a list of NWDAF providers (vendors) that are allowed to retrieve ML models from the NWDAF containing MTLF.”

3GPP TR 33.738 (v0.2.0) describes a study on security aspects of enablers for network automation for 5G. One of the objectives of this study is security for AI/ML model sharing and storage, which is identified as “Key Issue #3”. The following text from 3GPP TR 33.378 describes various aspects of this issue. In this text, “NFc” refers to a consumer NF and “NFp” refers to a producer NF, from the perspective of an AI/ML of interest.
***Begin 3GPP text***

### 5.3.1 Issue Details

AI/ML model is shared among NWDAFs and/or NFs (i.e., NWDAF to NWDAF, ADRF to NWDAF . . . ). In different scenarios, the NF producer of AI/ML model can store that model in ADRF, NWDAF or other entity.
ADRF (Analytical Data Repository Function) is being enhanced to store AI/ML models to facilitate the distribution and sharing of those models amongst NFs. Since AI/ML models and their algorithms are generally proprietary (i.e., subject to intellectual property rights of the designer), it is imperative to ensure that only the NFs which have been indeed provided with access authorization to the AI/ML models can read and use those models. Moreover, the ADRF itself cannot be considered as a fully trusted entity storing the sensitive AI/ML data models. Those models are indeed exposed at rest in ADRF.
The current authorization scheme defined by 3GPP for SBA works only at service level or resource/operation-level scope. This authorization granularity may be not sufficient in the AI/ML model sharing scenario, since the ADRF (Analytical Data Repository Function) or NWDAF, or any other network function which may store the AI/ML model, cannot verify whether the NF consumer is authorized to retrieve the AI/ML model.

### 5.3.2 Security Threats

An unauthorized NFc, in principle which is not eligible to retrieve a particular model stored by a NFp, could have access to the storage entity and retrieve the model.
If there is no protection against accessing and reading an AI/ML model from the ADRF stored by NFp, a compromised ADRF may expose algorithms and sensitive data to a non-authorized entity which can easily misuse it and/or distributed further to other entities, causing a bigger data security breach.

### 5.3.3 Potential Security Requirements

AI/ML models shall be protected between the entity which produces the ML model or stores the ML model in ADRF (e.g., NWDAF containing MTLF, NFp) and the entity which consumes the model (NFc).
ADRF (Analytical Data Repository Function), or any other network function which may store the AI/ML model, shall be able to authorize the NFc to retrieve that AI/ML model.
NF Service consumers shall be authorized to access to the AI/ML models in the ADRF (or any other NF which may store the ML model, for instance NWDAF MTLF).
***End 3GPP text**

3GPP TR 33.738 also describes a solution for authorization and authentication of AI/ML model transfer, which is identified as “solution #2”. This security solution protects an AI/ML model between a first entity (e.g., NF) that produces the AI/ML model (or stores the AI/ML model in ADRF) and a second entity that consumes the model (NFc). In this solution, an authorization token is used by ADRF to verify that the NFc is allowed to access the ML model.

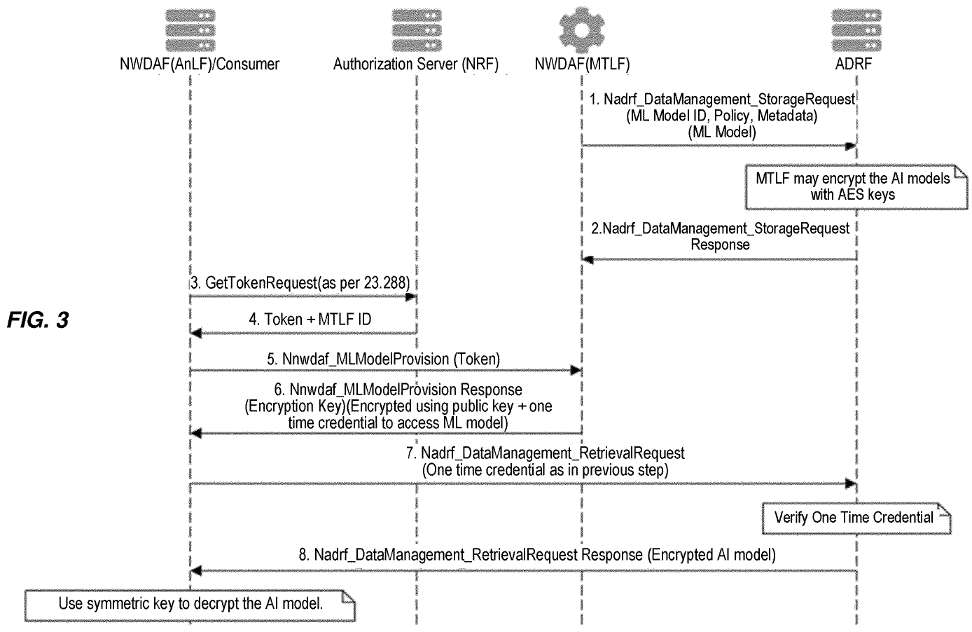

FIG. 3 shows a signaling diagram for this solution for authorization and authentication of AI/ML model transfer. As shown in FIG. 3, the signaling is between an NWDAF(AnLF)/NFc, an authorization server (e.g., NRF), an NWDAF(MTLF), and an ADRF. Although the operations shown in FIG. 3 are given numerical labels, this is intended to facilitate explanation rather than to require or imply any specific operational order, unless stated otherwise below.

In operation 1, the MTLF trains the ML model and sends ML Model to the ADRF by invoking the Nadrf_DataManagement_StorageRequest (ML Model) service operation. In addition to model metadata, this message can include ML model ID, analytics ID, Vendor ID, MAC or SHA256 Signature of the application binary, environment required for ML model execution, URL/link to retrieve configuration, and secrets/signing key/certificate to generate authentication credentials. MTLF may send an ML model encrypted using a symmetric key (e.g., AES key) before the storage.

In operation 2, ADRF stores the ML model and response as specified in 3GPP TS 23.288 (v17.6.0), except that the storage is performed by the ADRF. In operation 3, the NFc (e.g., NWDAF AnLF) contacts NRF and requests an access token using existing procedures specified in 3GPP TS 33.501 (v 17.7.0). In operation 4, NRF sends an access token along with MTLF ID using existing procedures specified in 3GPP TS 23.288.

In operation 5, NWDAF(AnLF) uses Nnwdaf_MLModelProvision service operation with the access token to request the ML model ID from NWDAF(MTLF), which retrieves the ML model ID based on ML analytics ID and/or ADRF ID. NWDAF(MTLF) also verifies received access token. In operation 6, NWDAF(MTLF) sends Nnwdaf_MLModelProvision Response that includes the encryption key used to encrypt the AI/ML model in operation 1. Additionally, the NWDAF(MTLF) can include one-time credentials to access the model from ADRF, including any of the following:
Nonce, which is shared in operation 1 as part of the metadata;
MAC or hash of a binary or random number shared in operation 1 as part of the data;
signing key as a private key of MTLF, with the public part being shared in operation 1;
credentials generated by MTLF's signing key, e.g., a JWT token or a certificate.
   One-time credentials can be used to limit the number of accesses from the NFc. Even so, a “one-time” credential may be used as a regular authorization token for accessing the ML model multiple times, i.e., not only once, as the name suggests.

In operation 7, NWDAF(AnLF) uses the ADRF service procedure to request the ML model, including the one-time credential received in operation 6. In operation 8, ADRF verifies the one-time credential and, if successfully verified, provides the stored AI/ML model to the NWDAF(AnLF).

AI/ML models (or more simply, ML models) are generally considered important intellectual property of their owners (e.g., 5GC vendors) and, as such, need to be kept secure at all times. The studies described in 3GPP TS 23.700-81 and 3GPP TR 33.738 include various objectives related to secure storage and sharing of AI/ML models, which are described as “key issues.” To support sharing of ML models among NWDAF provided by multiple vendors, there is a need for authentication and authorization of the receiving NWDAF and for security of the ML model during transfer and storage.

Current solutions for ML model sharing are based on certain the 5GC SBA, which was designed for control plane signaling involving messages that are (typically) relatively small compared to user plane traffic. Since the size of ML models (and any accompanying training data) can be quite large, existing SBA solutions may be inadequate to carry such information.

Additionally, in the current SBA, the NRF is in full control of authorizing other NFs (e.g., NWDAFs) that request access to various information (e.g., ML models). When an NRF is provided by a different entity than the owner of the ML model, the NRF may be unable to authorize access to the ML model or may improperly authorize access without permission from the ML model owner.

Embodiments of the present disclosure address these and other problems, issues, and/or difficulties by providing secure AI/ML model sharing between NFp (e.g., NWDAF MTLF) and NFc (e.g., NWDAF AnLF) and NFc (e.g., NWDAF AnLF) based on initial authorization by NRF and further authorization by the NFp. The further authorization can be based on an access token that includes a vendor ID of the NFp. The access token can be issued by the NRF to the NFc, which then forwards the access token to the NFp. Moreover, the NFp enforces the authorization by requesting a one-time URL from the ADRF (in which the ML model is stored) and sending the one-time URL only to the authorized NFc, which allows the NFc to retrieve the requested ML model. In this manner, embodiments transfer security credentials and parameters that facilitate secure storage and transfer of ML models, using non-SBA transfer mechanisms.

Embodiments of the present disclosure can provide various benefits and/or advantages. By providing the AI/ML model owner/producer the capability to protect the AI/ML model during various transfer, storage, and retrieval scenarios, embodiments improve the security of confidential and/or sensitive AI/ML models and thereby facilitate deployment of such models in a multi-vendor communication network, such as 5GC. Moreover, the NFp (e.g., NWDAF-MTLF) is in full control of the authorization for storage and use of its AI/ML models rather than relying on an NRF (which may be from a different vendor) as customary in the 5GC SBA.

In the following descriptions of various embodiments, the terms NFp and NWDAF(MTLF) may be used interchangeably, and the terms NFc and NWDAF(AnLF) may be used interchangeably. Similarly, the terms “model,” “ML model,” and “AI/ML model” may be used interchangeably.

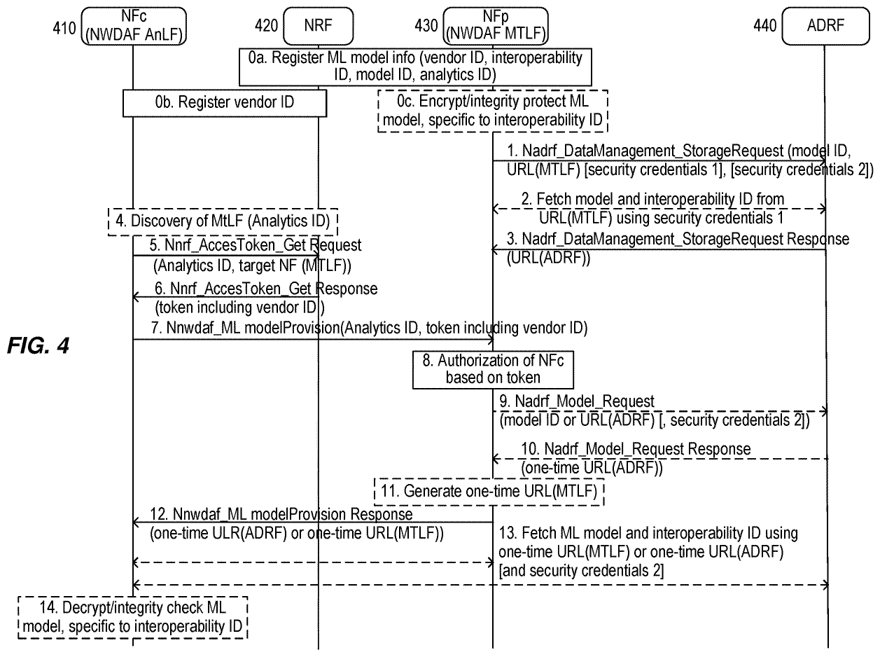

FIG. 4 shows a signaling diagram of a procedure involving an NWDAF(AnLF) 410, an NRF 420, an NWDAF(MTLF) 430, and an ADRF 440, according to some embodiments of the present disclosure. Although the operations shown in FIG. 4 are given numerical labels, this is intended to facilitate explanation rather than to require or imply any specific operational order, unless stated otherwise below.

In operation 0a, the NWDAF(MTLF) registers ML model information in its NF profile in the NRF. The registered ML model information may include the NWDAF(MTLF)'s vendor ID, an interoperability ID for the ML model, a model ID, and an analytics ID (for an analytic produced by the ML model). In operation 0b, the NWDAF(AnLF) registers various information in its NF profile in NRF, including a vendor ID. The NRF verifies the respective vendor IDs registered in these operations.

In operation 0c, which is optional, the NWDAF(MTLF) performs various security operations on the ML model, such as encryption and integrity protection. Some information about the security operations (e.g., type of operations, algorithms used, key IDs, etc.) are included in the interoperability ID (or related parameters) registered in operation 0a.

In operation 1, NWDAF(MTLF) invokes an Nadrf_DataManagement_StorageRequest service operation towards the ADRF, and includes a URL associated with the MTLF from which the ML model can be obtained. Note that URL(MTLF) can be a one-time use URL. The NWDAF(MTLF) may also include security credentials 1 to be used by the ADRF to fetch the ML model from the NWDAF(MTLF) and/or security credential 2 to be used by the NWDAF(MTLF) and other NFs (e.g., NWDAF(AnLF)) to access to the protected model in ADRF. In some embodiments, the NWDAF(MTLF) can protect either or both of these security credentials with any (pre-configured) security material known to NWDAF(MTLF) and ADRF.

In operation 2, ADRF securely fetches the protected ML model and interoperability ID (and any related parameters) from NWDAF(MTLF) using URL(MTLF) and (optionally) security credentials 1 received in operation 1. For example, the interoperability ID (and any related parameters) can identify security operations performed on the ML model, such as in operation 0c above. In operation 3, after storing the fetched ML model, the ADRF sends a URL associated with the ADRF from which the ML model can be obtained, e.g., at a later time by the NWDAF(MTLF) or other NFs.

In operation 4, NWDAF(AnLF) discovers the NWDAF(MTLF) using existing procedures specified in 3GPP TS 23.288. In operation 5, NWDAF(AnLF) contacts NRF to request an access token using existing procedures specified in 3GPP TS 33.501. The NWDAF(AnLF) includes in the request the analytics ID associated with the ML model and an identifier of a target NF for the operation, i.e., NWDAF(MTLF). In operation 6, the NRF checks whether the vendor ID of the NWDAF(AnLF) (registered in operation 0b) is one of the vendors IDs associated with the interoperability ID registered by the NWDAF (MTLF) in operation 0a. If the check is successful, then the NRF sends to the NWAF(AnLF) an access token that includes the vendor ID that was registered by the NWDAF(AnLF) in operation 0a.

In operation 7, NWDAF(AnLF) uses Nnwdaf_MLModelProvision or Nnwdaf MLModelInfo_Request service operation with the analytics ID and the access token received in operation 6 to obtain the ML model from NWDAF(MTLF). In operation 8, the NWDAF(MTLF) validates the received access token and authorizes the NWDAF(AnLF)'s request based on the vendor ID included in the access token.

After authorization in operation 8, if NWDAF(MTLF) stores the model locally, operation 11 described below is performed but not operations 9-10. then operation 11 is skipped.

If the ML model is stored in ADRF, operations 9-10 are performed after successful authorization in operation 8. In operation 9, NWDAF(MTLF) requests from ADRF a one-time use URL from which the ML model can be retrieved from ADRF by the requesting NWDAF(AnLF). The NWDAF(MTLF) can include with the request the model ID or the URL(ADRF) that it previously received in operation 3. In some embodiments, the NWDAF(MTLF) can include with the request the security credentials 2 that can be used when fetching the ML model. In some embodiments, the NWDAF(MTLF) can protect these security credentials with any (pre-configured) security material known to NWDAF(MTLF) and ADRF.

In operation 10, the ADRF verifies that the requesting NWDAF(MTLF) is the owner of the ML model associated with the model ID or the URL(ADRF) received in operation 9. If verification is successful, the ADRF provides a one-time use URL(ADRF) from which the ML model can be retrieved from the ADRF.

If NWDAF(MTLF) stores the ML model locally, operation 11 is performed after successful authorization in operation 8. In operation 11, the NWDAF(MTLF) generates a one-time-use URL(MTLF) from which the ML model can be retrieved from the NWDAF(MTLF).

In operation 12, the NWDAF(MTLF) sends to the requesting NWDAF(AnLF) either the one-time URL(ADRF) received in operation 10 or the one-time URL(MTLF) generated in operation 11. In operation 13, the NWDAF(AnLF) fetches the ML model and the interoperability ID (and any related parameters) using the one-time URL, and optionally security credentials 2, received in operation 12. For example, security credentials 2 are needed if the ML model is protected and cannot be fetched without providing these credentials.

As a variant to operation 12, rather than sending the one-time URL(ADRF) or the one-time URL(MTLF), the NWDAF(MTLF) sends the ML model to the NWDAF(AnLF) and optionally includes the interoperability ID (and any related parameters). In such variants, operation 13 is omitted.

In operation 14, which is optional, the NWDAF(AnLF) performs various security operations on the retrieved ML model, such as decryption and integrity checking. These security operations can be based on corresponding security operations identified by the interoperability ID (and any related parameters) received in operation 12, such as type of operations, algorithms used, key IDs, etc.

Although embodiments have been described above in the specific context of an NWDAF and its logical functions MTLF and AnLF, skilled persons will understand that underlying principles of the above-described embodiments are equally applicable to other NFs, logical functions, nodes, etc. (e.g., with different names) that perform similar operations as these respective entities.

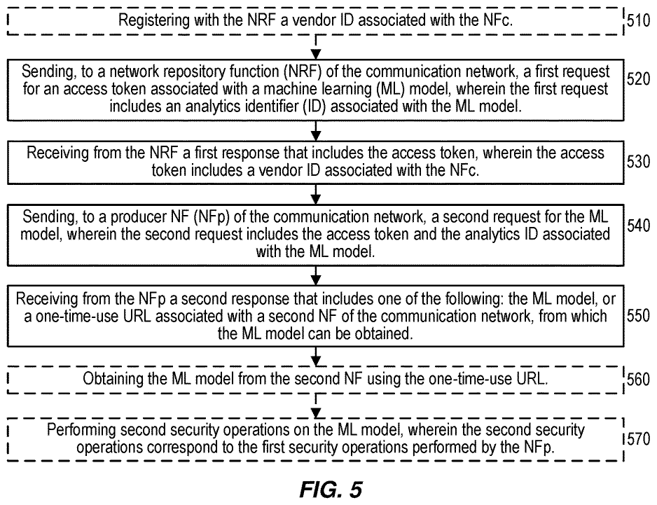

These embodiments described above can be further illustrated with reference to FIGS. 5-8, which depict exemplary methods (e.g., procedures) for a consumer NF, a producer NF, an NRF, and an ADRF, respectively. Put differently, various features of the operations described below correspond to various embodiments described above. The exemplary methods shown in FIGS. 5-8 can be used cooperatively (e.g., with each other and with other procedures described herein) to provide benefits, advantages, and/or solutions to problems described herein. Although the exemplary methods are illustrated in FIGS. 5-8 by specific blocks in particular orders, the operations corresponding to the blocks can be performed in different orders than shown and can be combined and/or divided into blocks and/or operations having different functionality than shown. Optional blocks and/or operations are indicated by dashed lines.

More specifically, FIG. 5 illustrates an exemplary method (e.g., procedure) for a consumer NF (NFc) of a communication network (e.g., 5GC), according to various embodiments of the present disclosure. The exemplary method shown in FIG. 5 can be performed by an NFc such as an NWDAF(AnLF) or by network equipment configured to implement an NFc (e.g., NWDAF(AnLF)), such as described elsewhere herein.

The exemplary method includes the operations of block 520, where the NFc sends, to an NRF of the communication network, a first request for an access token associated with an ML model. The first request includes an analytics identifier (ID) associated with the ML model. The exemplary method also includes the operations of block 530, where the NFc receives from the NRF a first response that includes the access token, which includes a vendor ID associated with the NFc. The exemplary method also includes the operations of block 540, where the NFc sends to a producer NF (NFp) of the communication network a second request for the ML model. The second request includes the access token and the analytics ID associated with the ML model. The exemplary method also includes the operations of block 540, where the NFc receives from the NFp a second response that includes one of the following: the ML model, or a one-time-use URL associated with a second NF of the communication network, from which the ML model can be obtained.

In some embodiments, the NFc is an NWDAF(AnLF) and/or the NFp is an NWDAF(MTLF).

In some embodiments, the second response also includes an interoperability ID associated with the NFp and with the ML model. The interoperability ID includes, identifies, or is associated with information about first security operations performed on the ML model by the NFp. In such embodiments, the exemplary method also includes the operations of block 570, where the NFc performs second security operations on the ML model, specifically second security operations that correspond to the first security operations performed by the NFp.

In some of these embodiments, the first security operations include encryption and/or integrity protection and the second security operations include decryption corresponding to the encryption and/or integrity checking corresponding to the integrity protection. In such embodiments, the interoperability ID includes, identifies, or is associated with one or more of the following information about the first security operations: which of the first security operations were performed, security algorithms used, and security keys used.

In some embodiments, the second response includes the one-time-use URL and the exemplary method also includes the operations of block 560, where the NFc obtains the ML model from the second NF using the one-time-use URL. In some of these embodiments, obtaining the ML model from the second NF in block 560 is based on security credentials associated with the ML model that are provided to the second NF by the NFc. In some of these embodiments, the second NF, from which the ML model is obtained using the one-time-use URL, is one of the following: the NFp, or an ADRF of the communication network.

In some embodiments, the exemplary method also includes the operations of block 510, where before sending the first request, the NFc registers with the NRF a vendor ID associated with the NFc. In such case, the second response is based on a match, correspondence, or relationship between the vendor ID associated with the NFc and an interoperability ID associated with the NFp and with the ML model.

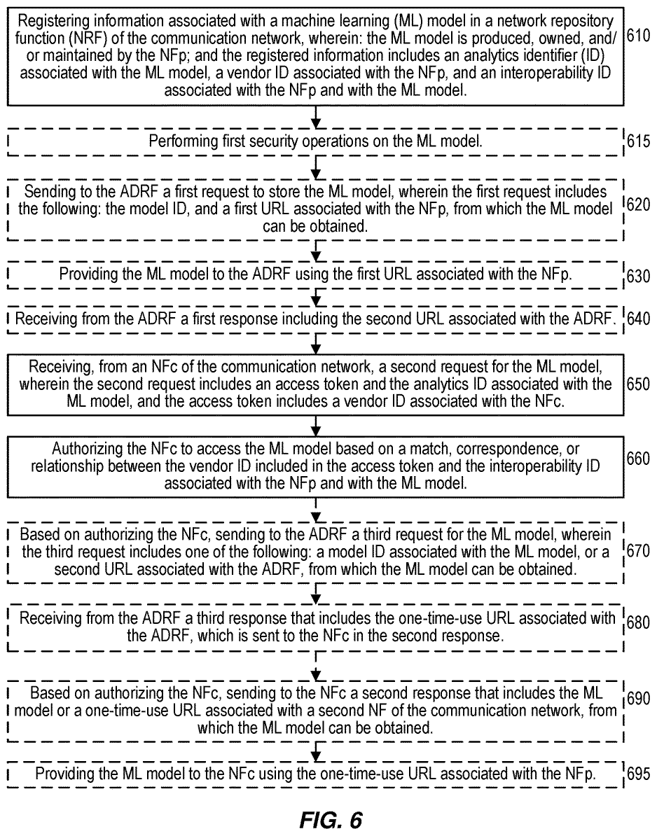

In addition, FIG. 6 illustrates an exemplary method (e.g., procedure) for an NFp of a communication network (e.g., 5GC), according to various embodiments of the present disclosure. The exemplary method shown in FIG. 6 can be performed by an NFp such as an NWDAF (MTLF) or by network equipment configured to implement an NFp (e.g., NWDAF (MTLF)), such as described elsewhere herein.

The exemplary method includes the operations of block 610, where the NFp registers information associated with an ML model in an NRF of the communication network. The ML model is produced, owned, and/or maintained by the NFp. The registered information includes an analytics identifier (ID) associated with the ML model, a vendor ID associated with the NFp, and an interoperability ID associated with the NFp and with the ML model. The exemplary method also includes the operations of block 650, where the NFp receives, from an NFc of the communication network, a second request for the ML model. The second request includes an access token and the analytics ID associated with the ML model. The access token includes a vendor ID associated with the NFc. The exemplary method also includes the operations of block 660, where the NFp authorizes the NFc to access the ML model based on a match, correspondence, or relationship between the vendor ID included in the access token and the interoperability ID associated with the NFp and with the ML model.

In some embodiments, the NFc is an NWDAF(AnLF) and/or the NFp is an NWDAF(MTLF).

In some embodiments, the exemplary method also includes the operations of block 615, where the NFp performs first security operations on the ML model. The interoperability ID includes, identifies, or is associated with information about the first security operations. In some of these embodiments, the first security operations include encryption and/or integrity protection and the interoperability ID includes, identifies, or is associated with one or more of the following information about the first security operations: which of the first security operations were performed, security algorithms used, and security keys used.

In some embodiments, the exemplary method also includes the operations of block 690, where based on authorizing the NFc, the NFp sends to the NFc a second response that includes the ML model or a one-time-use URL associated with a second NF of the communication network, from which the ML model can be obtained.

In some of these embodiments, the second NF associated with the one-time-use URL is the NFp, and the exemplary method also includes the operations of block 695, where the NFp subsequently provides the ML model to the NFc using the one-time-use URL associated with the NFp.

In other of these embodiments, the second NF associated with the one-time-use URL is an ADRF of the communication network, and the exemplary method also includes the following operations, labelled with corresponding block numbers:
(670) based on authorizing the NFc, sending to the ADRF a third request for the ML model, wherein the third request includes one of the following: a model ID associated with the ML model, or a second URL associated with the ADRF, from which the ML model can be obtained; and
(680) receiving from the ADRF a third response that includes the one-time-use URL associated with the ADRF, which is sent to the NFc in the second response.

In some variants of these embodiments, the exemplary method also includes the following operations, labelled with corresponding block numbers:
(620) sending to the ADRF a first request to store the ML model, wherein the first request includes the model ID and a first URL associated with the NFp, from which the ML model can be obtained; and
(630) providing the ML model to the ADRF using the first URL associated with the NFp; and
(640) receiving from the ADRF a first response including the second URL associated with the ADRF.

In some further variants, the first request also includes one or more security credentials associated with the ML model, and a first one of the security credentials is used by the NFp while providing the ML model to the ADRF.

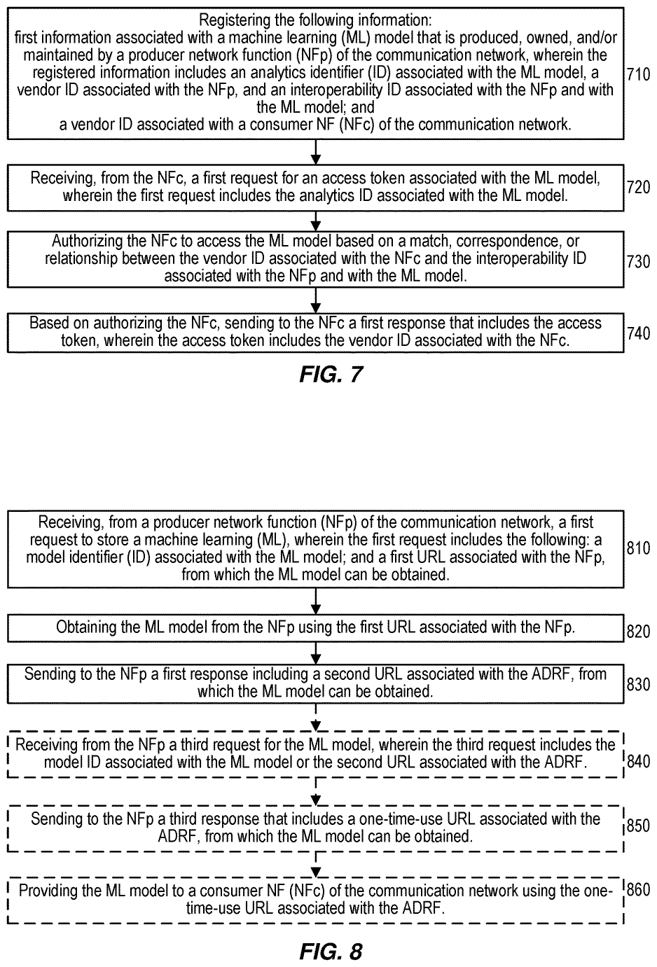

In addition, FIG. 7 illustrates an exemplary method (e.g., procedure) for an NRF of a communication network (e.g., 5GC), according to various embodiments of the present disclosure. The exemplary method shown in FIG. 7 can be performed by an NRF or by network equipment configured to implement an NRF, such as described elsewhere herein.

The exemplary method includes the operations of block 710, where the NRF registers the following information:
first information associated with an ML model that is produced, owned, and/or maintained by a NFp of the communication network, wherein the first information includes an analytics ID associated with the ML model, a vendor ID associated with the NFp, and an interoperability ID associated with the NFp and with the ML model; and
a vendor ID associated with a NFc of the communication network.

The exemplary method also includes the operations of block 720, where the NRF receives, from the NFc, a first request for an access token associated with the ML model. The first request includes the analytics ID associated with the ML model. The exemplary method also includes the operations of block 730, where the NRF authorizes the NFc to access the ML model based on a match, correspondence, or relationship between the vendor ID associated with the NFc and the interoperability ID associated with the NFp and with the ML model. The exemplary method also includes the operations of block 740, where based on authorizing the NFc, the NRF sends to the NFc a first response that includes the access token, wherein the access token includes the vendor ID associated with the NFc.

In some embodiments, the NFc is an NWDAF (AnLF). In some embodiments, the NFp is an NWDAF (MTLF).

In addition, FIG. 8 illustrates an exemplary method (e.g., procedure) for an ADRF of a communication network (e.g., 5GC), according to various embodiments of the present disclosure. The exemplary method shown in FIG. 8 can be performed by an ADRF or by network equipment configured to implement an ADRF, such as described elsewhere herein.

The exemplary method includes the operations of block 810, where the ADRF receives, from an NFp of the communication network, a first request to store an ML model. The first request includes a model ID associated with the ML model and a first URL associated with the NFp, from which the ML model can be obtained. The exemplary method also includes the operations of block 820, where the ADRF obtains the ML model from the NFp using the first URL associated with the NFp. The exemplary method also includes the operations of block 830, where the ADRF sends to the NFp a first response including a second URL associated with the ADRF, from which the ML model can be obtained.

In some embodiments, the exemplary method also includes the operations of block 840, where the ADRF receives from the NFp a third request for the ML model. The third request includes the model ID associated with the ML model or the second URL associated with the ADRF. The exemplary method also includes the operations of block 850, where the ADRF sends to the NFp a third response that includes a one-time-use URL associated with the ADRF, from which the ML model can be obtained. In some of these embodiments, the exemplary method also includes the operations of block 860, where the ADRF provides the ML model to an NFc of the communication network using the one-time-use URL associated with the ADRF.

In some variants of these embodiments, the first request also includes one or more security credentials associated with the ML model and a first one of the security credentials is used by the ADRF while obtaining the ML model from the NFp (e.g., in block 820). In some further variants, a second one of the security credentials is used by the ADRF while providing the ML model to the NFc (e.g., in block 860).

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

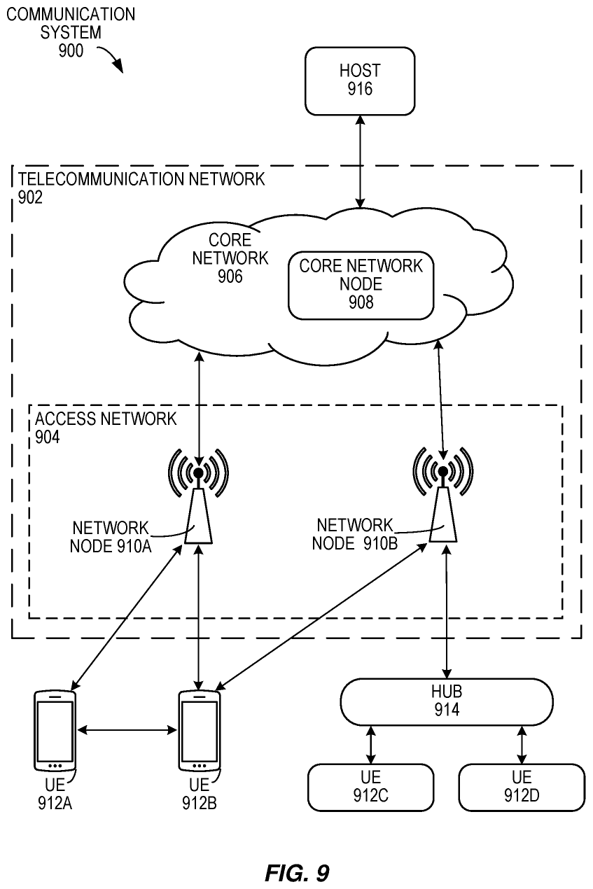

FIG. 9 shows an example of a communication system 900 in accordance with some embodiments. In this example, communication system 900 includes telecommunication network 902 that includes an access network 904 (e.g., RAN) and a core network 906, which includes one or more core network nodes 908. Access network 904 includes one or more access network nodes, such as network nodes 910a-b (one or more of which may be generally referred to as network nodes 910), or any other similar 3GP) access node or non-3GPP access point. Network nodes 910 facilitate direct or indirect connection of UEs, such as by connecting UEs 912a-d (one or more of which may be generally referred to as UEs 912) to core network 906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 900 may include any number of wired or wireless networks, network nodes, UEs, and/or any other components or systems that may facilitate or participate in the communication of data and/or signals whether via wired or wireless connections. Communication system 900 may include and/or interface with any type of communication, telecommunication, data, cellular, radio network, and/or other similar type of system.

UEs 912 may be any of a wide variety of communication devices, including wireless devices arranged, configured, and/or operable to communicate wirelessly with network nodes 910 and other communication devices. Similarly, network nodes 910 are arranged, capable, configured, and/or operable to communicate directly or indirectly with UEs 912 and/or with other network nodes or equipment in telecommunication network 902 to enable and/or provide network access, such as wireless network access, and/or to perform other functions, such as administration in telecommunication network 902.

In the depicted example, core network 906 connects network nodes 910 to one or more hosts, such as host 916. These connections may be direct or indirect via one or more intermediary networks or devices. In other examples, network nodes may be directly coupled to hosts. Core network 906 includes one or more core network nodes (e.g., 908) that are structured with hardware and software components. Features of these components may be substantially similar to those described with respect to the UEs, network nodes, and/or hosts, such that the descriptions thereof are generally applicable to the corresponding components of core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 916 may be under the ownership or control of a service provider other than an operator or provider of access network 904 and/or telecommunication network 902, and may be operated by the service provider or on behalf of the service provider. Host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 902 is a cellular network that implements 3GPP standardized features. Accordingly, telecommunication network 902 may support network slicing to provide different logical networks to different devices that are connected to telecommunication network 902. For example, telecommunication network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 912 are configured to transmit and/or receive information without direct human interaction. For instance, a UE may be designed to transmit information to access network 904 on a predetermined schedule, when triggered by an internal or external event, or in response to requests from access network 904. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, hub 914 communicates with access network 904 to facilitate indirect communication between one or more UEs (e.g., UE 912c and/or 912d) and network nodes (e.g., network node 910b). In some examples, hub 914 may be a controller, router, content source and analytics, or any of the other communication devices described herein regarding UEs. For example, hub 914 may be a broadband router enabling access to core network 906 for the UEs. As another example, hub 914 may be a controller that sends commands or instructions to one or more actuators in the UEs. Commands or instructions may be received from the UEs, network nodes 910, or by executable code, script, process, or other instructions in hub 914. As another example, hub 914 may be a data collector that acts as temporary storage for UE data and, in some embodiments, may perform analysis or other processing of the data. As another example, hub 914 may be a content source. For example, for a UE that is a VR headset, display, loudspeaker or other media delivery device, hub 914 may retrieve VR assets, video, audio, or other media or data related to sensory information via a network node, which hub 914 then provides to the UE either directly, after performing local processing, and/or after adding additional local content. In still another example, hub 914 acts as a proxy server or orchestrator for the UEs, in particular in if one or more of the UEs are low energy IoT devices.

Hub 914 may have a constant/persistent or intermittent connection to network node 910b. Hub 914 may also allow for a different communication scheme and/or schedule between hub 914 and UEs (e.g., UE 912c and/or 912d), and between hub 914 and core network 906. In other examples, hub 914 is connected to core network 906 and/or one or more UEs via a wired connection. Moreover, hub 914 may be configured to connect to an M2M service provider over access network 904 and/or to another UE over a direct connection. In some scenarios, UEs may establish a wireless connection with network nodes 910 while still connected via hub 914 via a wired or wireless connection. In some embodiments, hub 914 may be a dedicated hub-that is, a hub whose primary function is to route communications to/from the UEs from/to network node 910b. In other embodiments, hub 914 may be a non-dedicated hub-that is, a device which is capable of operating to route communications between the UEs and network node 910b, but which is additionally capable of operating as a communication start and/or end point for certain data channels.

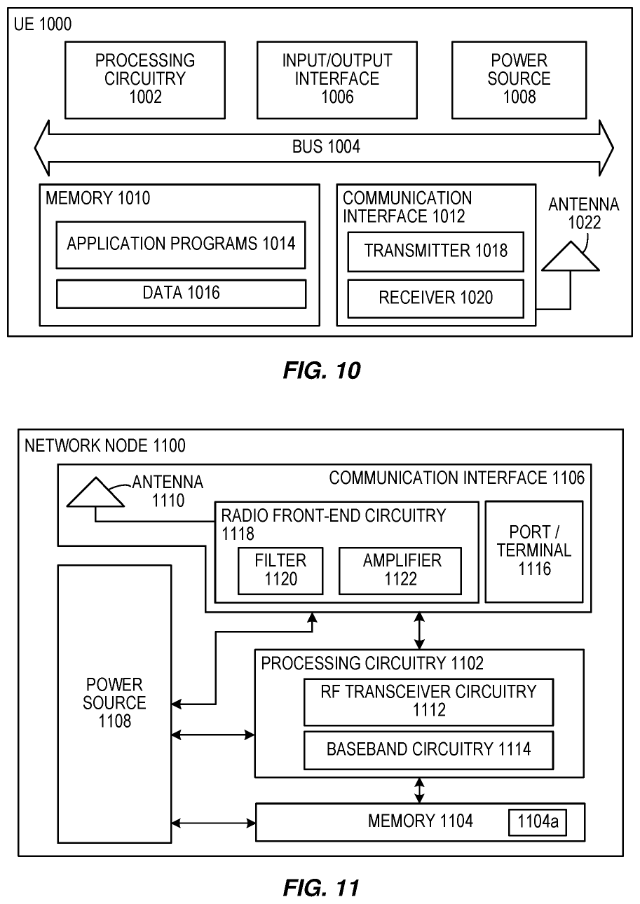

FIG. 10 shows a UE 1000 in accordance with some embodiments. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1000 includes processing circuitry 1002 that is operatively coupled via bus 1004 to input/output interface 1006, power source 1008, memory 1010, communication interface 1012, and possibly other components not explicitly shown. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

Processing circuitry 1002 is configured to process instructions and data and may be configured to implement any sequential state machine operative to execute instructions stored as machine-readable computer programs in memory 1010. Processing circuitry 1002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1002 may include multiple central processing units (CPUs).

In the example, input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1008 is structured as a battery or battery pack. Other types of power sources, such as an external power source (e.g., an electricity outlet), photovoltaic device, or power cell, may be used. Power source 1008 may further include power circuitry for delivering power from power source 1008 itself, and/or an external power source, to the various parts of UE 1000 via input circuitry or an interface such as an electrical power cable. Delivering power may be, for example, for charging of power source 1008. Power circuitry may perform any formatting, converting, or other modification to the power from power source 1008 to make the power suitable for the respective components of UE 1000 to which power is supplied.

Memory 1010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1010 includes one or more application programs 1014, such as an operating system, web browser application, a widget, gadget engine, or other application, and corresponding data 1016. Memory 1010 may store, for use by UE 1000, any of a variety of various operating systems or combinations of operating systems.

Memory 1010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1010 may allow UE 1000 to access instructions, application programs and the like, stored on transitory or non-transitory memory media, to off-load data, or to upload data. An article of manufacture, such as one utilizing a communication system may be tangibly embodied as or in memory 1010, which may be or comprise a device-readable storage medium.

Processing circuitry 1002 may be configured to communicate with an access network or other network using communication interface 1012. Communication interface 1012 may comprise one or more communication subsystems and may include or be communicatively coupled to an antenna 1022. Communication interface 1012 may include one or more transceivers used to communicate, such as by communicating with one or more remote transceivers of another device capable of wireless communication (e.g., another UE or a network node in an access network). Each transceiver may include transmitter 1018 and/or a 1020 appropriate to provide network communications (e.g., optical, electrical, frequency allocations, and so forth). Moreover, transmitter 1018 and/or receiver 1020 may be coupled to one or more antennas (e.g., 1022) and may share circuit components, software, or firmware, or alternatively be implemented separately.

In the illustrated embodiment, communication functions of communication interface 1012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

FIG. 11 shows a network node 1100 in accordance with some embodiments. Examples of network nodes include, but are not limited to, access points (e.g., radio access points) and base stations (e.g., radio base stations, Node Bs, eNBs, gNBs, etc.).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

As a more specific example, one or more network nodes 1100 can be configured to perform operations attributed to various NFs in the descriptions herein of various methods or procedures. As a more specific example, the one or more network nodes 1100 can be configured to perform operations attributed to a consumer NF (e.g., NWDAF AnLF), a producer NF (e.g., NWDAF MTLF), an NRF, and an ADRF.

Network node 1100 includes processing circuitry 1102, memory 1104, communication interface 1106, and power source 1108. Network node 1100 may be composed of multiple physically separate components (e.g., a NodeB component and a RNC component, or a BTS component and a BSC component, etc.), which may each have their own respective components. In certain scenarios in which network node 1100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1100 may be configured to support multiple radio access technologies (RATs). In such embodiments, some components may be duplicated (e.g., separate memory 1104 for different RATs) and some components may be reused (e.g., a same antenna 1110 may be shared by different RATs). Network node 1100 may also include multiple sets of the various illustrated components for different wireless technologies integrated into network node 1100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1100.

Processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1100 components, such as memory 1104, to provide network node 1100 functionality.

In some embodiments, processing circuitry 1102 includes a system on a chip (SOC). In some embodiments, processing circuitry 1102 includes one or more of radio frequency (RF) transceiver circuitry 1112 and baseband processing circuitry 1114. In some embodiments, RF transceiver circuitry 1112 and baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

Memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1102. Memory 1104 may store any suitable instructions, data, or information, including a computer program, software, an application including one or more of logic, rules, code, tables, and/or other instructions (collectively denoted computer program 1104a, which may be in the form of a computer program product) capable of being executed by processing circuitry 1102 and utilized by network node 1100. Memory 1104 may be used to store any calculations made by processing circuitry 1102 and/or any data received via communication interface 1106. In some embodiments, processing circuitry 1102 and memory 1104 is integrated.

Communication interface 1106 is used in wired or wireless communication of signaling and/or data between a network node, access network, and/or UE. As illustrated, communication interface 1106 comprises port(s)/terminal(s) 1116 to send and receive data, for example to and from a network over a wired connection. Communication interface 1106 also includes radio front-end circuitry 1118 that may be coupled to, or in certain embodiments a part of, antenna 1110. Radio front-end circuitry 1118 comprises filters 1120 and amplifiers 1122. Radio front-end circuitry 1118 may be connected to an antenna 1110 and processing circuitry 1102. The radio front-end circuitry may be configured to condition signals communicated between antenna 1110 and processing circuitry 1102. Radio front-end circuitry 1118 may receive digital data that is to be sent out to other network nodes or UEs via a wireless connection. Radio front-end circuitry 1118 may convert the digital data into a radio signal having the appropriate channel and bandwidth parameters using a combination of filters 1120 and/or amplifiers 1122. The radio signal may then be transmitted via antenna 1110. Similarly, when receiving data, antenna 1110 may collect radio signals which are then converted into digital data by radio front-end circuitry 1118. The digital data may be passed to processing circuitry 1102. In other embodiments, the communication interface may comprise different components and/or different combinations of components.

In certain alternative embodiments, network node 1100 does not include separate radio front-end circuitry 1118, instead, processing circuitry 1102 includes radio front-end circuitry and is connected to antenna 1110. Similarly, in some embodiments, all or some of RF transceiver circuitry 1112 is part of communication interface 1106. In still other embodiments, communication interface 1106 includes one or more ports or terminals 1116, radio front-end circuitry 1118, and RF transceiver circuitry 1112, as part of a radio unit (not shown), and communication interface 1106 communicates with baseband processing circuitry 1114, which is part of a digital unit (not shown).

Antenna 1110 may include one or more antennas, or antenna arrays, configured to send and/or receive wireless signals. Antenna 1110 may be coupled to radio front-end circuitry 1118 and may be any type of antenna capable of transmitting and receiving data and/or signals wirelessly. In certain embodiments, antenna 1110 is separate from network node 1100 and connectable to network node 1100 through an interface or port.

Antenna 1110, communication interface 1106, and/or processing circuitry 1102 may be configured to perform any receiving operations and/or certain obtaining operations described herein as being performed by the network node. Any information, data and/or signals may be received from a UE, another network node and/or any other network equipment. Similarly, antenna 1110, communication interface 1106, and/or processing circuitry 1102 may be configured to perform any transmitting operations described herein as being performed by the network node. Any information, data and/or signals may be transmitted to a UE, another network node and/or any other network equipment.

Power source 1108 provides power to the various components of network node 1100 in a form suitable for the respective components (e.g., at a voltage and current level needed for each respective component). Power source 1108 may further comprise, or be coupled to, power management circuitry to supply the components of network node 1100 with power for performing the functionality described herein. For example, network node 1100 may be connectable to an external power source (e.g., the power grid, an electricity outlet) via an input circuitry or interface such as an electrical cable, whereby the external power source supplies power to power circuitry of power source 1108. As a further example, power source 1108 may comprise a source of power in the form of a battery or battery pack which is connected to, or integrated in, power circuitry. The battery may provide backup power should the external power source fail.

Embodiments of network node 1100 may include additional components beyond those shown in FIG. 11 for providing certain aspects of the network node's functionality, including any of the functionality described herein and/or any functionality necessary to support the subject matter described herein. For example, network node 1100 may include user interface equipment to allow input of information into network node 1100 and to allow output of information from network node 1100. This may allow a user to perform diagnostic, maintenance, repair, and other administrative functions for network node 1100.

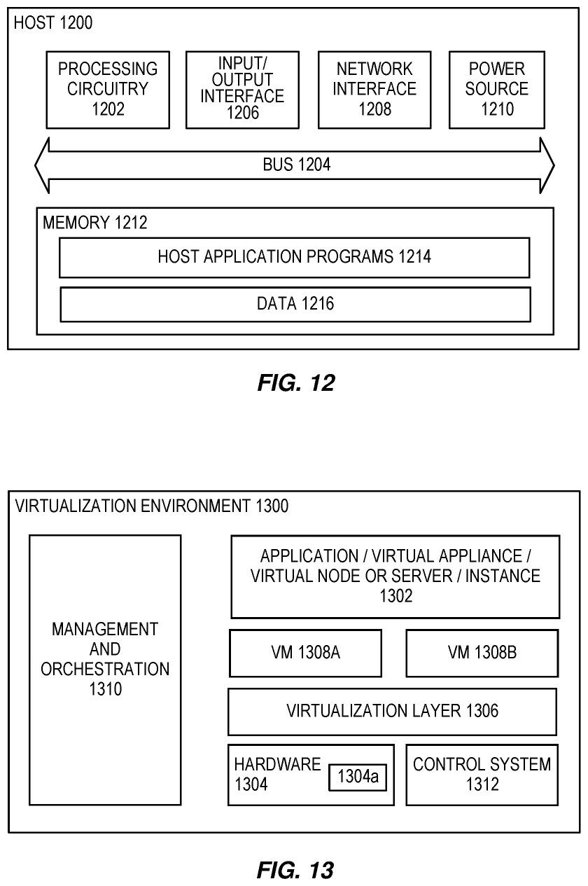

FIG. 12 is a block diagram of a host 1200, which may be an embodiment of host 916 of FIG. 9, in accordance with various aspects described herein. Host 1200 may be or comprise various combinations hardware and/or software, including a standalone server, a blade server, a cloud-implemented server, a distributed server, a virtual machine, container, or processing resources in a server farm. Host 1200 may provide one or more services to one or more UEs.

Host 1200 includes processing circuitry 1202 that is operatively coupled via a bus 1204 to an input/output interface 1206, a network interface 1208, a power source 1210, and a memory 1212. Other components may be included in other embodiments. Features of these components may be substantially similar to those described with respect to the devices of previous figures, such as FIGS. 10 and 11, such that the descriptions thereof are generally applicable to the corresponding components of host 1200.

Memory 1212 may include one or more computer programs including one or more host application programs 1214 and data 1216, which may include user data, e.g., data generated by a UE for host 1200 or data generated by host 1200 for a UE. Embodiments of host 1200 may utilize only a subset or all of the components shown. Host application programs 1214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1214 may also provide for user authentication and licensing checks and may periodically report health, routes, and content availability to a central node, such as a device in or on the edge of a core network. Accordingly, host 1200 may select and/or indicate a different host for over-the-top services for a UE. Host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 is a block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1302 (which may alternatively be called software instances, virtual appliances, network functions, virtual nodes, virtual network functions, etc.) are run in the virtualization environment 1300 to implement some of the features, functions, and/or benefits of some of the embodiments disclosed herein.

For example, various NFs (or portions thereof) described herein in relation to other figures can be implemented as virtual network functions 1302 in virtualization environment 1300. As a more specific example, a consumer NF (e.g., NWDAF AnLF), a producer NF (e.g., NWDAF MTLF), an NRF, and/or an ADRF can be implemented as virtual network functions 1302 in virtualization environment 1300.

Hardware 1304 includes processing circuitry, memory that stores software and/or instructions (collectively denoted computer program 1304a, which may be in the form of a computer program product) executable by hardware processing circuitry, and/or other hardware devices as described herein, such as a network interface, input/output interface, and so forth. Software may be executed by the processing circuitry to instantiate one or more virtualization layers 1306 (also referred to as hypervisors or virtual machine monitors (VMMs)), provide VMs 1308a-b (one or more of which may be generally referred to as VMs 1308), and/or perform any of the functions, features and/or benefits described in relation with some embodiments described herein. The virtualization layer 1306 may present a virtual operating platform that appears like networking hardware to VMs 1308.

VMs 1308 comprise virtual processing, virtual memory, virtual networking or interface and virtual storage, and may be run by a corresponding virtualization layer 1306. Different embodiments of the instance of a virtual appliance 1302 may be implemented on one or more of VMs 1308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 1308 may be a software implementation of a physical machine that runs programs as if they were executing on a physical, non-virtualized machine. Each VM 1308, and that part of hardware 1304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1308 on top of hardware 1304 and corresponds to the application 1302.

Hardware 1304 may be implemented in a standalone network node with generic or specific components. Hardware 1304 may implement some functions via virtualization. Alternatively, hardware 1304 may be part of a larger cluster of hardware (e.g. such as in a data center or CPE) where many hardware nodes work together and are managed via management and orchestration 1310, which, among others, oversees lifecycle management of applications 1302. In some embodiments, hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1312 which may alternatively be used for communication between hardware nodes and radio units.

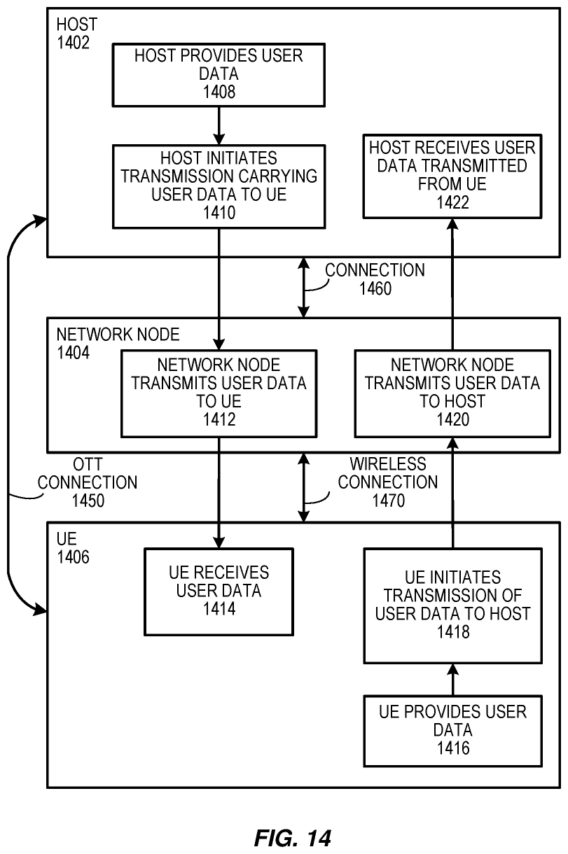

FIG. 14 shows a communication diagram of a host 1402 communicating via a network node 1404 with a UE 1406 over a partially wireless connection in accordance with some embodiments. Example implementations, in accordance with various embodiments, of the UE (such as a UE 912a of FIG. 9 and/or UE 1000 of FIG. 10), network node (such as network node 910a of FIG. 9 and/or network node 1100 of FIG. 11), and host (such as host 916 of FIG. 9 and/or host 1200 of FIG. 12) discussed in the preceding paragraphs will now be described with reference to FIG. 14.

Like host 1200, embodiments of host 1402 include hardware, such as a communication interface, processing circuitry, and memory. Host 1402 also includes software, which is stored in or accessible by host 1402 and executable by the processing circuitry. The software includes a host application that may be operable to provide a service to a remote user, such as UE 1406 connecting via an over-the-top (OTT) connection 1450 extending between UE 1406 and host 1402. In providing the service to the remote user, a host application may provide user data which is transmitted using OTT connection 1450.

Network node 1404 includes hardware enabling it to communicate with host 1402 and UE 1406. Connection 1460 may be direct or pass through a core network (like core network 906 of FIG. 9) and/or one or more other intermediate networks, such as one or more public, private, or hosted networks. For example, an intermediate network may be a backbone network or the Internet.

UE 1406 includes hardware and software, which is stored in or accessible by UE 1406 and executable by the UE's processing circuitry. The software includes a client application, such as a web browser or operator-specific “app” that may be operable to provide a service to a human or non-human user via UE 1406 with the support of host 1402. In host 1402, an executing host application may communicate with the executing client application via OTT connection 1450 terminating at UE 1406 and host 1402. In providing the service to the user, the UE's client application may receive request data from the host's host application and provide user data in response to the request data. OTT connection 1450 may transfer both the request data and the user data. The UE's client application may interact with the user to generate the user data that it provides to the host application through OTT connection 1450.

OTT connection 1450 may extend via a connection 1460 between host 1402 and network node 1404 and via wireless connection 1470 between network node 1404 and UE 1406 to provide the connection between host 1402 and UE 1406. Connection 1460 and wireless connection 1470, over which OTT connection 1450 may be provided, have been drawn abstractly to illustrate the communication between host 1402 and UE 1406 via network node 1404, without explicit reference to any intermediary devices and the precise routing of messages via these devices.

As an example of transmitting data via OTT connection 1450, in step 1408, host 1402 provides user data, which may be performed by executing a host application. In some embodiments, the user data is associated with a particular human user interacting with UE 1406. In other embodiments, the user data is associated with a UE 1406 that shares data with host 1402 without explicit human interaction. In step 1410, host 1402 initiates a transmission carrying the user data towards UE 1406. Host 1402 may initiate the transmission responsive to a request transmitted by UE 1406. The request may be caused by human interaction with UE 1406 or by operation of the client application executing on UE 1406. The transmission may pass via network node 1404, in accordance with the teachings of the embodiments described throughout this disclosure. Accordingly, in step 1412, network node 1404 transmits to UE 1406 the user data that was carried in the transmission that host 1402 initiated, in accordance with the teachings of the embodiments described throughout this disclosure. In step 1414, UE 1406 receives the user data carried in the transmission, which may be performed by a client application executed on UE 1406 associated with the host application executed by host 1402.

In some examples, UE 1406 executes a client application which provides user data to host 1402. The user data may be provided in reaction or response to the data received from host 1402. Accordingly, in step 1416, UE 1406 may provide user data, which may be performed by executing the client application. In providing the user data, the client application may further consider user input received from the user via an input/output interface of UE 1406. Regardless of the specific manner in which the user data was provided, UE 1406 initiates, in step 1418, transmission of the user data towards host 1402 via network node 1404. In step 1420, in accordance with the teachings of the embodiments described throughout this disclosure, network node 1404 receives user data from UE 1406 and initiates transmission of the received user data towards host 1402. In step 1422, host 1402 receives the user data carried in the transmission initiated by UE 1406.

One or more of the various embodiments improve the performance of OTT services provided to UE 1406 using OTT connection 1450, in which wireless connection 1470 forms the last segment. For example, by providing an AI/ML model owner/producer with the ability to protect the AI/ML model during various transfer, storage, and retrieval scenarios, embodiments improve the security of confidential and/or sensitive AI/ML models and thereby facilitate deployment of such models in a multi-vendor communication network, such as 5GC. In this manner, embodiments facilitate improvement of network performance based on deployed AI/ML models, and consequently increased the value of OTT services delivered over networks improved in this manner.

In an example scenario, factory status information may be collected and analyzed by host 1402. As another example, host 1402 may process audio and video data which may have been retrieved from a UE for use in creating maps. As another example, host 1402 may collect and analyze real-time data to assist in controlling vehicle congestion (e.g., controlling traffic lights). As another example, host 1402 may store surveillance video uploaded by a UE. As another example, host 1402 may store or control access to media content such as video, audio, VR or AR which it can broadcast, multicast or unicast to UEs. As other examples, host 1402 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 1450 between host 1402 and UE 1406, in response to variations in the measurement results. The measurement procedure and/or the network functionality for reconfiguring the OTT connection may be implemented in software and hardware of host 1402 and/or UE 1406. In some embodiments, sensors (not shown) may be deployed in or in association with other devices through which OTT connection 1450 passes; the sensors may participate in the measurement procedure by supplying values of the monitored quantities exemplified above, or supplying values of other physical quantities from which software may compute or estimate the monitored quantities. The reconfiguring of OTT connection 1450 may include message format, retransmission settings, preferred routing etc. ; the reconfiguring need not directly alter the operation of network node 1404. Such procedures and functionalities may be known and practiced in the art. In certain embodiments, measurements may involve proprietary UE signaling that facilitates measurements of throughput, propagation times, latency, and the like, by host 1402. The measurements may be implemented in that software causes messages to be transmitted, in particular empty or ‘dummy’ messages, using OTT connection 1450 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for performing one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Example embodiments of the techniques and apparatus described herein include, but are not limited to, the following enumerated embodiments:
A1. A method for a consumer network function (NFc) of a communication network, the method comprising:
   sending, to a network repository function (NRF) of the communication network, a first request for an access token associated with a machine learning (ML) model, wherein the first request includes an analytics identifier (ID) associated with the ML model;
   receiving from the NRF a first response that includes the access token, wherein the access token includes a vendor ID associated with the NFc;
   sending, to a producer NF (NFp) of the communication network, a second request for the ML model, wherein the second request includes the access token and the analytics ID associated with the ML model; and
   receiving from the NFp a second response that includes one of the following: the ML model, or
      a one-time-use universal resource locator (URL) associated with a second NF of the communication network, from which the ML model can be obtained.
A2. The method of embodiment A1, wherein one or more of the following applies:
   the NFc is an analytics logical function of a network data analytics function, NWDAF (AnLF); and
   the NFp is a model training logical function of the network data analytics function, NWDAF (MTLF).
A3. The method of any of embodiments A1-A2, wherein:
   the second response also includes an interoperability ID associated with the NFp and with the ML model;
   the interoperability ID includes, identifies, or is associated with information about first security operations performed on the ML model by the NFp; and
   the method further comprises performing second security operations on the ML model, wherein the second security operations correspond to the first security operations performed by the NFp.
A4. The method of embodiment A3, wherein:
   the first security operations include encryption and/or integrity protection;
   the second security operations include decryption corresponding to the encryption and/or integrity checking corresponding to the integrity protection; and
   the interoperability ID includes, identifies, or is associated with one or more of the following information about the first security operations: which of the first security operations were used, security algorithms used, and security keys used.
A5. The method of any of embodiments A1-A4, wherein:
   the second response includes the one-time use URL; and
   the method further comprises obtaining the ML model from the second NF using the one-time-use URL.
A6. The method of embodiment A5, wherein obtaining the ML model from the second NF is based on security credentials associated with the ML model that are provided to the second NF by the NFc.
A7. The method of any of embodiments A5-A6, wherein the second NF, from which the ML model is obtained using the one-time-use URL, is one of the following: the NFp, or an analytics data repository function (ADRF) of the communication network.
A8. The method of any of embodiments A1-A7, wherein:
   the method further comprises, before sending the first request, registering with the NRF a vendor ID associated with the NFc; and
   the second response is based on a match, correspondence, or relationship between the vendor ID associated with the NFc and an interoperability ID associated with the NFp and with the ML model.
B1. A method for a producer network function (NFp) of a communication network, the method comprising:
   registering information associated with a machine learning (ML) model in a network repository function (NRF) of the communication network, wherein:
      the ML model is produced, owned, and/or maintained by the NFp, and
      the registered information includes an analytics identifier (ID) associated with the ML model, a vendor ID associated with the NFp, and an interoperability ID associated with the NFp and with the ML model;
   receiving, from a consumer NF (NFc) of the communication network, a second request for the ML model, wherein:
      the second request includes an access token and the analytics ID associated with the ML model, and
      the access token includes a vendor ID associated with the NFc;
   authorizing the NFc to access the ML model based on a match, correspondence, or relationship between the vendor ID included in the access token and the interoperability ID associated with the NFp and with the ML model.
B2. The method of embodiment B1, wherein:
   the method further comprise performing first security operations on the ML model; and
   the interoperability ID includes, identifies, or is associated with information about the first security operations.
B3. The method of embodiment B2, wherein:
   the first security operations include encryption and/or integrity protection; and
   the interoperability ID includes, identifies, or is associated with one or more of the following information about the first security operations: which of the first security operations were used, security algorithms used, and security keys used.
B4. The method of any of embodiments B1-B3, further comprising, based on authorizing the NFc, sending to the NFc a second response that includes the ML model or a one-time-use universal resource locator (URL) associated with a second NF of the communication network, from which the ML model can be obtained.
B5. The method of embodiment B4, wherein:
   the second NF associated with the one-time-use URL is the NFp; and
   the method further comprises subsequently providing the ML model to the NFc using the one-time-use URL associated with the NFp.
B6. The method of embodiment B4, wherein:
   the second NF associated with the one-time-use URL is an analytics data repository function (ADRF) of the communication network; and
   the method further comprises:
      based on authorizing the NFc, sending to the ADRF a third request for the ML model, wherein the third request includes one of the following:
         a model ID associated with the ML model, or
         a second URL associated with the ADRF, from which the ML model can be obtained; and
      receiving from the ADRF a third response that includes the one-time-use URL associated with the ADRF, which is sent to the NFc in the second response.
B7. The method of embodiment B6, further comprising;
   sending to the ADRF a first request to store the ML model, wherein the first request includes the model ID and a first URL associated with the NFp, from which the ML model can be obtained;
   providing the ML model to the ADRF using the first URL associated with the NFp;
   receiving from the ADRF a first response including the second URL associated with the ADRF.
B8. The method of embodiment B7, wherein:
   the first request also includes one or more security credentials associated with the ML model; and
   a first one of the security credentials is used by the NFp while providing the ML model to the ADRF.
B9. The method of any of embodiments B1-B8, wherein one or more of the following applies:
   the NFc is an analytics logical function of a network data analytics function, NWDAF (AnLF); and
   the NFp is a model training logical function of the network data analytics function, NWDAF (MTLF).
C1. A method for a network repository function (NRF) of a communication network, the method comprising:
   registering the following information:
      first information associated with a machine learning (ML) model that is produced, owned, and/or maintained by a producer network function (NFp) of the communication network, wherein the first information includes an analytics identifier (ID) associated with the ML model, a vendor ID associated with the NFp, and an interoperability ID associated with the NFp and with the ML model; and
      a vendor ID associated with a consumer NF (NFc) of the communication network;
   receiving, from the NFc, a first request for an access token associated with the ML model, wherein the first request includes the analytics ID associated with the ML model;
   authorizing the NFc to access the ML model based on a match, correspondence, or relationship between the vendor ID associated with the NFc and the interoperability ID associated with the NFp and with the ML model; and
   based on authorizing the NFc, sending to the NFc a first response that includes the access token, wherein the access token includes the vendor ID associated with the NFc.
C2. The method of embodiment C1, wherein one or more of the following applies:
   the NFc is an analytics logical function of a network data analytics function, NWDAF (AnLF); and
   the NFp is a model training logical function of the network data analytics function, NWDAF (MTLF).
D1. A method for an analytics data repository function (ADRF) of a communication network, the method comprising:
   receiving, from a producer network function (NFp) of the communication network, a first request to store a machine learning (ML), wherein the first request includes a model identifier (ID) associated with the ML model and a first URL associated with the NFp, from which the ML model can be obtained;
   obtaining the ML model from the NFp using the first URL associated with the NFp;
   sending to the NFp a first response including a second URL associated with the ADRF, from which the ML model can be obtained.
D2. The method of embodiment D1, further comprising:
   receiving from the NFp a third request for the ML model, wherein the third request includes the model ID associated with the ML model or the second URL associated with the ADRF; and
   sending to the NFp a third response that includes a one-time-use URL associated with the ADRF, from which the ML model can be obtained.
D3. The method of embodiment D2, further comprising providing the ML model to a consumer NF (NFc) of the communication network using the one-time-use URL associated with the ADRF.
D4. The method of embodiment D3, wherein:
   the first request also includes one or more security credentials associated with the ML model; and
   a first one of the security credentials is used by the ADRF while obtaining the ML model from the NFp.
D5. The method of embodiment D4, wherein a second one of the security credentials is used the ADRF while providing the ML model to the NFc.
D6. The method of embodiment D4, wherein one or more of the following applies:
   the NFc is an analytics logical function of a network data analytics function, NWDAF (AnLF); and
   the NFp is a model training logical function of the network data analytics function, NWDAF (MTLF).
E1. A consumer network function (NFc) of a communication network, wherein:
   the NFc is implemented by communication interface circuitry and processing circuitry that are operably coupled; and
   the processing circuitry and interface circuitry are configured to perform operations corresponding to any of the methods of embodiments A1-A9.
E2. A consumer network function (NFc) of a communication network, the NFc being configured to perform operations corresponding to any of the methods of embodiments A1-A9.
E3. A non-transitory, computer-readable medium storing computer-executable instructions that, when executed by processing circuitry associated with a consumer network function (NFc) a communication network, configure the NFc to perform operations corresponding to any of the methods of embodiments A1-A9.
E4. A computer program product comprising computer-executable instructions that, when executed by processing circuitry associated with a consumer network function (NFc) of a communication network, configure the NFc to perform operations corresponding to any of the methods of embodiments A1-A9.
F1. A producer network function (NFp) of a communication network, wherein:
   the NFp is implemented by communication interface circuitry and processing circuitry that are operably coupled; and
   the processing circuitry and interface circuitry are configured to perform operations corresponding to any of the methods of embodiments B1-B9.
F2 A producer network function (NFp) of a communication network, the NFp being configured to perform operations corresponding to any of the methods of embodiments B1-B9.
F3. A non-transitory, computer-readable medium storing computer-executable instructions that, when executed by processing circuitry associated with a producer network function (NFp) of a communication network, configure the NFp to perform operations corresponding to any of the methods of embodiments B1-B9.
F4. A computer program product comprising computer-executable instructions that, when executed by processing circuitry associated with a producer network function (NFp) of a communication network, configure the NFp to perform operations corresponding to any of the methods of embodiments B1-B9.
G1. A network repository function (NRF) of a communication network, wherein:
   the NRF is implemented by communication interface circuitry and processing circuitry that are operably coupled; and
   the processing circuitry and interface circuitry are configured to perform operations corresponding to any of the methods of embodiments C1-C2.
G2. A network repository function (NRF) of a communication network, the NRF being configured to perform operations corresponding to any of the methods of embodiments C1-C2.
G3. A non-transitory, computer-readable medium storing computer-executable instructions that, when executed by processing circuitry associated with a network repository function (NRF) of a communication network, configure the NRF to perform operations corresponding to any of the methods of embodiments C1-C2.
G4. A computer program product comprising computer-executable instructions that, when executed by processing circuitry associated with a network repository function (NRF) of a communication network, configure the NRF to perform operations corresponding to any of the methods of embodiments C1-C2.
H1. An analytics data repository function (ADRF) of a communication network, wherein:
   the ADRF is implemented by communication interface circuitry and processing circuitry that are operably coupled; and
   the processing circuitry and interface circuitry are configured to perform operations corresponding to any of the methods of embodiments D1-D6.
H2. An analytics data repository function (ADRF) of a communication network, the ADRF being configured to perform operations corresponding to any of the methods of embodiments D1-D6.
H3. A non-transitory, computer-readable medium storing computer-executable instructions that, when executed by processing circuitry associated with an analytics data repository function (ADRF) of a communication network, configure the ADRF to perform operations corresponding to any of the methods of embodiments D1-D6.
H4. A computer program product comprising computer-executable instructions that, when executed by processing circuitry associated with an analytics data repository function (ADRF) of a communication network, configure the ADRF to perform operations corresponding to any of the methods of embodiments D1-D6.

1.-49. (canceled)

50. A method for a consumer network function (NFc) of a communication network, the method comprising:
sending, to a network repository function (NRF) of the communication network, a first request for an access token associated with a machine learning (ML) model, wherein the first request includes an analytics identifier (ID) associated with the ML model;
receiving from the NRF a first response that includes the access token, wherein the access token includes a vendor ID associated with the NFc;
sending, to a producer network function (NFp) of the communication network, a second request for the ML model, wherein the second request includes the access token and the analytics ID associated with the ML model; and
receiving from the NFp a second response that includes one of the following:
the ML model, or
a one-time-use universal resource locator (URL) associated with a second network function (NF) of the communication network, from which the ML model can be obtained.

51. The method of claim 50, wherein one or more of the following applies:
the NFc is an analytics logical function of a network data analytics function, NWDAF (AnLF); and
the NFp is a model training logical function of the network data analytics function, NWDAF (MTLF).

52. The method of claim 50, wherein:
the second response also includes an interoperability ID associated with the NFp and with the ML model;
the interoperability ID includes, identifies, or is associated with information about first security operations performed on the ML model by the NFp; and
the method further comprises performing second security operations on the ML model, wherein the second security operations correspond to the first security operations performed by the NFp.

53. The method of claim 52, wherein:
the first security operations include encryption and/or integrity protection;
the second security operations include decryption corresponding to the encryption and/or integrity checking corresponding to the integrity protection; and
the interoperability ID includes, identifies, or is associated with one or more of the following information about the first security operations: which of the first security operations were performed, security algorithms used, and security keys used.

54. The method of claim 50, wherein:
the second response includes the one-time use URL; and
the method further comprises obtaining the ML model from the second NF using the one-time-use URL.

55. The method of claim 54, wherein obtaining the ML model from the second NF is based on security credentials associated with the ML model that are provided to the second NF by the NFc.

56. The method of claim 54, wherein the second NF, from which the ML model is obtained using the one-time-use URL, is one of the following: the NFp, or an analytics data repository function (ADRF) of the communication network.

57. The method of claim 50, wherein:
the method further comprises, before sending the first request, registering with the NRF a vendor ID associated with the NFc; and
the second response is based on a match, correspondence, or relationship between the following: the vendor ID associated with the NFc, and an interoperability ID associated with the NFp and with the ML model.

58. A method for a producer network function (NFp) of a communication network, the method comprising:
registering information associated with a machine learning (ML) model in a network repository function (NRF) of the communication network, wherein:
the ML model is produced, owned, and/or maintained by the NFp, and
the registered information includes the following: an analytics identifier (ID) associated with the ML model, a vendor ID associated with the NFp, and an interoperability ID associated with the NFp and with the ML model;
receiving, from a consumer network function (NFc) of the communication network, a second request for the ML model, wherein:
the second request includes an access token and the analytics ID associated with the ML model, and
the access token includes a vendor ID associated with the NFc; and
authorizing the NFc to access the ML model based on a match, correspondence, or relationship between the following: the vendor ID included in the access token, and the interoperability ID associated with the NFp and with the ML model.

59. The method of claim 58, wherein:
the method further comprise performing first security operations on the ML model; and
the interoperability ID includes, identifies, or is associated with information about the first security operations.

60. The method of claim 59, wherein:
the first security operations include encryption and/or integrity protection; and
the interoperability ID includes, identifies, or is associated with one or more of the following information about the first security operations: which of the first security operations were performed, security algorithms used, and security keys used.

61. The method of claim 58, further comprising, based on authorizing the NFc, sending to the NFc a second response that includes one of the following:
the ML model, or
a one-time-use universal resource locator (URL) associated with a second network function (NF) of the communication network, from which the ML model can be obtained.

62. The method of claim 61, wherein:
the second NF associated with the one-time-use URL is the NFp; and
the method further comprises subsequently providing the ML model to the NFc using the one-time-use URL associated with the NFp.

63. The method of claim 61, wherein:
the second NF associated with the one-time-use URL is an analytics data repository function (ADRF) of the communication network; and
the method further comprises:
based on authorizing the NFc, sending to the ADRF a third request for the ML model, wherein the third request includes one of the following:
a model ID associated with the ML model, or
a second URL associated with the ADRF, from which the ML model can be obtained; and
receiving from the ADRF a third response that includes the one-time-use URL associated with the ADRF, which is sent to the NFc in the second response.

64. The method of claim 63, further comprising;
sending to the ADRF a first request to store the ML model, wherein the first request includes the following: the model ID, and a first URL associated with the NFp, from which the ML model can be obtained;
providing the ML model to the ADRF using the first URL associated with the NFp; and
receiving from the ADRF a first response including the second URL associated with the ADRF.

65. The method of claim 64, wherein:
the first request also includes one or more security credentials associated with the ML model; and
a first one of the security credentials is used by the NFp while providing the ML model to the ADRF.

66. The method of claim 58, wherein one or more of the following applies:
the NFc is an analytics logical function of a network data analytics function, NWDAF (AnLF); and
the NFp is a model training logical function of the network data analytics function, NWDAF (MTLF).

67. A method for a network repository function (NRF) of a communication network, the method comprising:
registering the following information:
a vendor ID associated with a consumer network function (NFc) of the communication network; and
first information associated with a machine learning (ML) model that is produced, owned, and/or maintained by a producer network function (NFp) of the communication network, wherein the first information includes the following:
an analytics identifier (ID) associated with the ML model,
a vendor ID associated with the NFp, and
an interoperability ID associated with the NFp and with the ML model;
receiving, from the NFc, a first request for an access token associated with the ML model, wherein the first request includes the analytics ID associated with the ML model;
authorizing the NFc to access the ML model based on a match, correspondence, or relationship between the following: the vendor ID associated with the NFc, and the interoperability ID associated with the NFp and with the ML model; and
based on authorizing the NFc, sending to the NFc a first response that includes the access token, wherein the access token includes the vendor ID associated with the NFc.

68. The method of claim 67, wherein one or more of the following applies:
the NFc is an analytics logical function of a network data analytics function, NWDAF (AnLF); and
the NFp is a model training logical function of the network data analytics function, NWDAF (MTLF).

69. A method for an analytics data repository function (ADRF) of a communication network, the method comprising:
receiving, from a producer network function (NFp) of the communication network, a first request to store a machine learning (ML) model, wherein the first request includes the following:
a model identifier (ID) associated with the ML model, and
a first universal resource locator (URL) associated with the NFp;
obtaining the ML model from the NFp using the first URL; and
sending to the NFp a first response including a second URL associated with the ADRF, from which the ML model can be obtained.
